(19) United States
(12) Patent Application Publication
(10) Pub. No.: US 2008/0137251 A1
(43) Pub. Date: Jun. 12, 2008

(54) Repair circuitry with an enhanced ESD protection device

(75) Inventors: Sung-Chieh Lin, Hsinchu (TW); Ming Hsien Tsai, Sinidian City (TW); Kuo-Ji Chen, Wu-Ku (TW)

Correspondence Address: Howard Chen, Esq.;Preston Gates & Ellis LLP, Suite 1700, 55 Second Street, San Francisco, CA, 94105, US

(73) Assignee: Taiwan Semiconductor Manufacturing Co., Ltd.

(21) Appl. No.: 11/638,342

(22) Filed: Dec. 12, 2006

(51) Int. Cl. H02H 3/20

(52) U.S. Cl. 361/91.1

(57) ABSTRACT

A repair circuitry consisting of at least one electrical fuse forming part of a conduction path between a positive voltage supply (VQ) pad and a complimentary lower voltage supply source (Vss). The repair circuitry includes at least one switching device and at least one control circuit. The at least one first switching device has a control terminal and is coupled between the Vss and the at least one electrical fuse. The at least one control circuit is coupled to the control terminal and the Vss respectively. Upon an application of a positive high voltage to the VQ pad, the at least one control circuit delays the turn-on state of the at least one first switching device for a predetermined period of time, thereby preventing the at least one electrical fuse from being mistakenly programmed.

### BACKGROUND

The present invention relates generally to a repair circuitry for a semiconductor device, and more particularly to a repair circuitry with an electrostatic discharge (ESD) protection device to prevent an electrical fuse from being mistakenly blown by an ESD event.

The System-on-Chip (SoC) typically embeds memory IP cores with very large aggregate bit counts per SoC. Because such memory IP cores are of high cell density, the embedded memories are more prone to defects that already exist in silicon substrate than any other component on the chip. New self-repair algorithm is therefore developed to test and repair embedded memory devices on SoCs. This new technology can improve typical SoC yields by as much as 82 percent over traditional external test and repair systems.

Such self-repair algorithms are usually achieved by applying electrical fuse circuits in semiconductor devices, such as a chip ID, serial number, security key, analog trimming, memory redundancy, and boot ROM patch. The electrical fuses are programming silicided poly fuses, which generally consist of, for example, polycrystalline silicon, or a similar suitable material that can be fused or melted through the action of energy. So, by passing a relatively large current through a particular electrical fuse, the electrical fuse will melt and disconnect a pre-programmed circuit. Eventually, the connection will go through another path, thereby reprogramming the circuit.

However, electrical fuses can be mistakenly programmed by stray currents during an ESD event. During an ESD event, a charge is transferred between one or more pins of the integrated circuits and another conducting object in less than one microsecond. For instance, the market requirement for human-body mode ESD durability is 2 kilovolts. The standard human-body model assumes a static charge transfer of about 0.1 micro-Coulombs (10⁻⁷ C) upon static electricity discharge between a human and a chip. Such charge is relatively large as the gate oxide thickness is only about 10⁻⁶ cm in sub-micron manufacturing process. That means the electric fields in the gate oxide are on the order of 10¹³ v/cm. As a result, the electrical fuse can be easily blown by an ESD event in a very short time. For the same reason, ESD events are even more devastating to semiconductor devices made by nano-scale semiconductor manufacturing processes.

FIG. 1 shows a repair circuitry 100 for a memory IP core. The repair circuitry 100 includes an electrical fuse 102 coupled to a positive power supply (VQ) pad and a clamp circuit 110 consisting of two clamp diodes 111 and 112 for ESD protection. It is known that on ESD a stray current can flow over device surfaces or junctions. As illustrated in FIG. 1, ESD stray current can flow through path P1 or path P2. Even though the VQ pad has an ESD clamp circuit 110, some stray currents may still flow through the fuse path P2. Referring to FIG. 1, PMOS (P-channel Metal-Oxide Silicon) transistor 101 is controlled by a bit-line (BL) and the NMOS (N-channel Metal-Oxide Silicon) transistor 103 by a word-line (WL). For path P2, if both the PMOS transistor 101 and the NMOS transistor 103 are in a turned-on or even weakly turned-on state during an ESD event, then the ESD stray current will flow through path P2 created by the electrical fuse 102, and will accidentally blow the electrical fuse 102.

As such, what is needed is a new design of the repair circuitry that can automatically switch off its connection to the positive power supply pad when an ESD event occurs, and then automatically switch on its connection during normal operations.

### SUMMARY

In view of the foregoing, to prevent an electrical fuse circuit of a repair circuitry from being damaged by an ESD zap, the repair circuitry of the invention consisting of at least one electrical fuse forming part of a conduction path between a positive voltage supply (VQ) pad and a complimentary lower voltage supply source (Vss). The repair circuitry includes at least one switching device and at least one control circuit. The at least one switching device has a control terminal and is coupled between the Vss and the at least one electrical fuse. The at least one control circuit is coupled to the control terminal of the at least one switching device and the Vss respectively. During an ESD event when a positive high voltage is applied to the VQ pad, the at least one control circuit delays the turn-on state of the at least one first switching device for a predetermined period of time, thereby preventing the at least one electrical fuse from being mistakenly programmed.

A preferred embodiment of the invention also provides a method for preventing an electrical fuse from being blown during an electrostatic discharge (ESD) event. The method includes the steps of providing a switching device coupled between a complimentary lower voltage supply source (Vss) and the electrical fuse; and then turning off the switching device for a predetermined period of time when a positive high voltage is applied during an ESD event. Consequently, the stray currents of the ESD are blocked during the ESD event to prevent the electrical fuse from being blown by mistake.

The circuitry and method of operating the invention, however, together with additional objectives and advantages thereof will be best understood from the following description of specific embodiments when read in connection with the accompanying drawings.

### BRIEF DESCRIPTION OF THE DRAWINGS

FIG. 1 illustrates a conventional repair circuitry for a memory IP core without an enhanced ESD protection device;

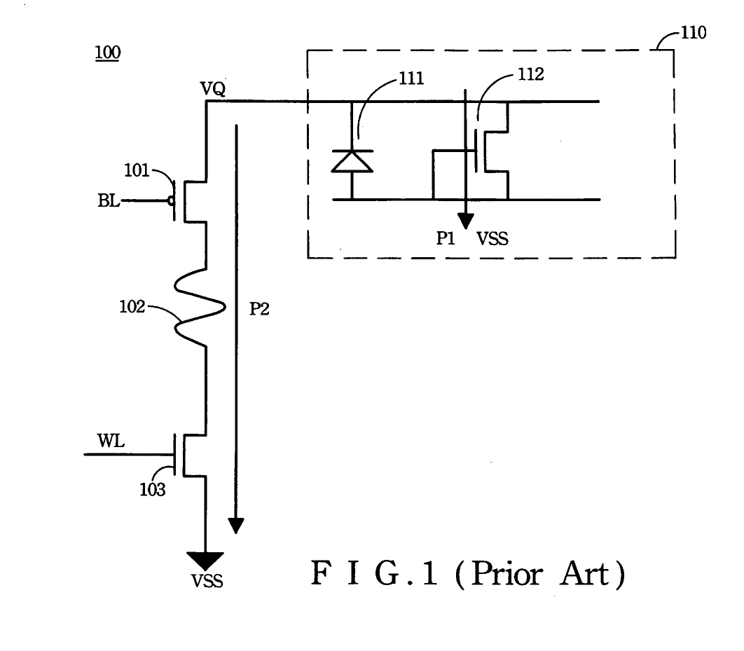

FIG. 2 illustrates an improved repair circuitry for a memory IP core according to a preferred embodiment of the present invention;

FIG. 3A illustrates a detailed implementation of the control circuit for the repair circuitry according to a preferred embodiment of the present invention; and

FIG. 3B illustrates a detailed implementation of the control circuit for the repair circuitry according to another preferred embodiment of the present invention.

### DESCRIPTION

In the following detailed description, specific details are set forth in order to provide a thorough understanding of the invention. However, it will be understood that the present invention may be practiced without these specific details. In other instances, well-known methods and circuits have not been described in detail, so as not to obscure the present invention.

As discussed above, semiconductor devices manufactured by sub-micron or even nano-scale manufacturing processes are more susceptible to ESD events, as compared with earlier manufacturing processes. Thus, the present invention provides an improved repair circuitry with an enhanced ESD protection device that can prevent electrical fuses from being mistakenly blown during an ESD event.

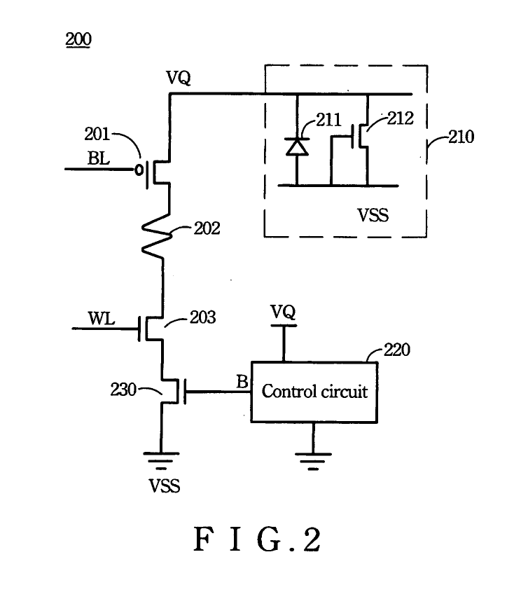

FIG. 2 shows the repair circuitry 200 with an enhanced ESD protection device according to a preferred embodiment of the invention. In addition to the ESD clamp circuit 210, which includes two diodes 211 and 212, the improved repair circuitry 200 further includes a switching device 230 and a control circuit 220.

In FIG. 2, the embodiment has at least one electrical fuse 202 forming part of one conduction path from a positive power supply (VQ) pad to a complimentary lower supply voltage (Vss). The switching device 230 is implemented as an NMOS transistor and designed to provide a direct path to the Vss to dissipate current quickly to the ground. The control circuit 220 is coupled to the VQ pad and the gate terminal of the switching device 230 for driving the switching device 230. During an ESD event when the VQ pad supplies high voltage, the control circuit 220 is driven to turn off the switching device 230, thereby preventing the ESD stray current from flowing through the conduction path formed partly by the electrical fuse 202.

The conduction path further includes two switching devices, a PMOS transistor 201 and an NMOS transistor 203. The PMOS transistor 201 is controlled by a predetermined bit-line (BL), which is coupled to the gate of the PMOS transistor 201 through an odd number of inverters (not shown). On the other hand, the NMOS transistor 203 is controlled by a predetermined word-line (WL), which is coupled to the gate of the NMOS transistor through an even number of inverters (not shown). During the programming stage when the electrical fuse 202 is assigned to be programmed, the bit-line BL and word-line WL will be enabled to turn on the PMOS transistor 201 and the NMOS transistor 203, respectively. In this embodiment, the cascaded switching devices 201, 203 and 230 have the advantage of decreasing snapback occurrence during ESD zapping.

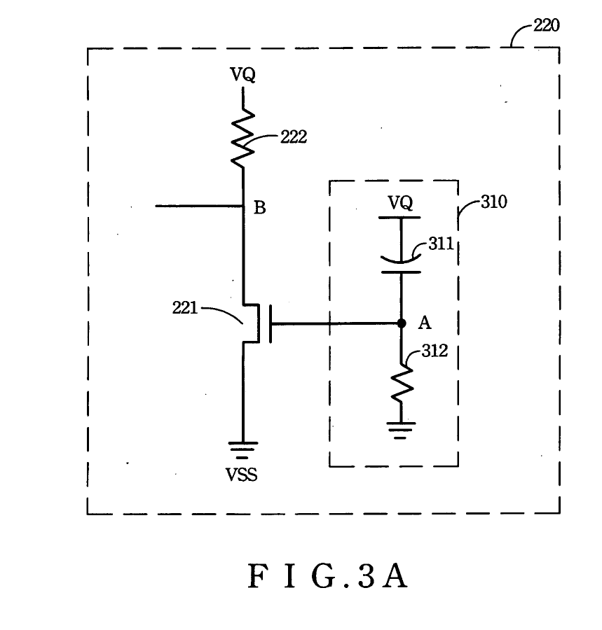

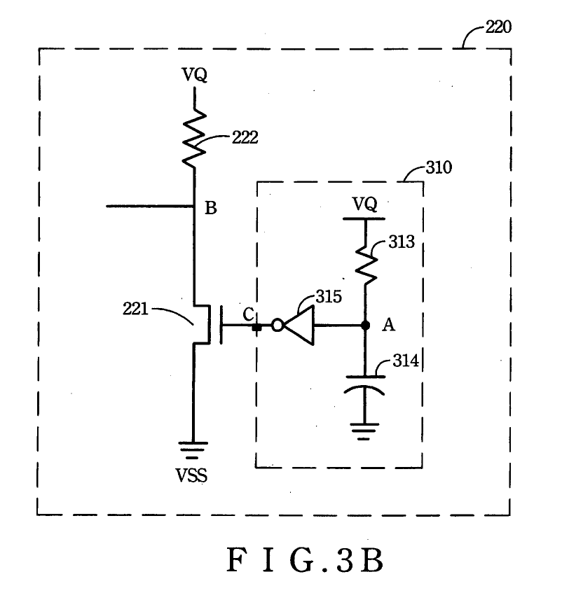

FIG. 3A illustrates a detailed implementation of the control circuit 220 for the repair circuitry 200 shown in FIG. 2 according to one preferred embodiment of the present invention. During an ESD event when high voltage is applied to the VQ pad, the voltage at node A is high due to the capacitor 311. So, at that moment, the NMOS transistor 221 is on and pulls down node B. The resistor 222 limits the current flowing through the NMOS transistor 221. With node B at low voltage, the switching NMOS transistor 230 is turned off, so that the fuse path is protected. But over time the capacitor 311 will charge up and cause the voltage at node A to drop to Vss. Eventually, the NMOS transistor 221 will be turned off. Then, the node B voltage will be pulled up by the high voltage at the VQ pad, which will turn on the switching NMOS transistor 230 to allow the repair circuitry 200 to function normally.

If the high voltage applied at the VQ pad is due to an ESD event, which lasts only a very short period of time, the initial turn-off of the switching NMOS 230 will protect the electrical fuse 202 from being damaged by ESD stray currents. On the other hand, if the high voltage applied at the VQ pad is intended to blow the electrical fuse 202, then after a predetermined period of time, which is determined by the values of the resistor 312 and capacitor 311, the switching NMOS transistor 230 will be turned on, allowing the electrical fuse 202 to be blown as intended. Basically, the resistor 312 and the capacitor 311 form a pull-down circuitry 310, which functions in a way of turning on the NMOS transistor 221 initially, and turning it off after a predetermined period of time. The pull-down circuitry 310 delays the turned-off state of the NMOS transistor 221 for the predetermined period of time that is determined by the resistance value of the resistor 312 and the capacitance value of the capacitor 311. On the other hand, the capacitor 311 can be implemented as a PMOS capacitor or an NMOS capacitor depending on practical applications.

The function carried out by the pull-down circuitry 310 can be implemented by various other circuitries. Alternatively, the pull-down circuitry 310 can include an even number of inverters between node A and the gate of the NMOS transistor 221 (not shown), and still functions in the same way as that of the control circuit 220 as described in FIG. 3A.

FIG. 3B illustrates another implementation of the control circuit 220 shown in FIG. 2. The resistor 222 and the NMOS transistor 221 are connected in the same way as shown in FIG. 3A. The difference is in the implementation of the pull-down circuitry 310. Here, a resistor 313 and a capacitor 314 are serially connected with a common terminal, designated as node A. The common terminal serves as an input for the inverter 315. The other terminal of the resistor 313 is connected to the VQ pad. And the other terminal of the capacitor 314 is connected to Vss. When a high voltage is applied to the VQ pad, node A voltage maintains at Vss due to the capacitor 314. Node C is inverted to high voltage, which turns on the NMOS transistor 221. Then, node B is pulled low, which in turn turns off the switching transistor 230 shown in FIG. 2. But overtime the high voltage at VQ will charge up the capacitor 314, and raise the node A voltage. Eventually, node C is inverted to Vss, which will turn off the NMOS transistor 221. Then, the node B voltage will be pulled high, which will turn on the switching NMOS transistor 230 to allow the repair circuitry 200 to function normally. The resistor 313 limits the rate that the capacitor 314 is charged up by the high voltage at pad VQ. Increasing resistance value of the resistor 313 can put more delays on the turn-on state of the switching NMOS transistor 230.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A repair circuitry having at least one electrical fuse forming part of a conduction path between a positive voltage supply (VQ) pad and a complimentary lower voltage supply source (Vss), the repair circuitry comprising:
at least one first switching device having a control terminal and coupled between the Vss and the at least one electrical fuse; and
at least one control circuit coupled to the control terminal and the Vss respectively,
wherein the at least one control circuit delays the turn-on state of the at least one first switching device for a predetermined period of time upon an application of a positive high voltage to the VQ pad.

2. The repair circuitry of claim 1, wherein the at least one first switching device is an NMOS transistor with a gate as the control terminal, a source coupled to the Vss and a drain coupled to the at least one electrical fuse.

3. The repair circuitry of claim 1, wherein the at least one control circuit comprises:
a pull-down circuitry coupled between the VQ pad and the Vss; and
at least one NMOS transistor with a source coupled to the Vss, a drain couple to the control terminal, and a gate coupled to the pull-down circuitry,
wherein the pull-down circuitry delays the turned-off state of the at least one NMOS transistor for the predetermined period of time.

4. The repair circuitry of claim 3, wherein the pull-down circuitry comprises:
at least one capacitor coupled to the VQ pad; and
at least one resistor coupled between the at least one capacitor and the Vss with a common terminal of the at least one resistor and the at least one capacitor coupled to the gate of the at least one NMOS transistor.

5. The repair circuitry of claim 3, wherein the pull-down circuitry comprises:
at least one resistor coupled to the VQ pad;
at least one capacitor coupled between the at least one resistor and the Vss; and
an inverter having an input end coupled to a common terminal of the at least one resistor and the at least one capacitor and an output end coupled to the gate of the at least one NMOS transistor.

6. The repair circuitry of claim 1 further comprising:
at least one second switching device controlled by a predetermined bit-line and coupled between the at least one first switching device and the at least one electrical fuse.

7. The repair circuitry of claim 6, wherein the at least one second switching device is a PMOS transistor, and the predetermined bit-line is coupled to the gate of the PMOS transistor through an odd number of inverters.

8. The repair circuitry of claim 1 further comprising:
at least one third switching device controlled by a predetermined word-line and coupled between the at least one electrical fuse and the Vss.

9. The repair circuitry of claim 8, wherein the at least one third switching device is an NMOS transistor and the predetermined word-line is coupled to the gate of the NMOS transistor through an even number of inverters.

10. A repair circuitry having at least one electrical fuse forming part of a conduction path between a positive voltage supply (VQ) pad and a complimentary lower voltage supply source (Vss), the repair circuitry comprising:
at least one first NMOS transistor with a source coupled to the Vss and a drain coupled to the at least one electrical fuse; and
at least one control circuit coupled to a gate of the at least one first NMOS transistor and the Vss respectively,
wherein the at least one control circuit delays the turned-on state of the at least one first NMOS transistor for a predetermined period of time upon an application of a positive high voltage to the VQ pad.

11. The repair circuitry of claim 10, wherein the at least one control circuit comprises:
a pull-down circuitry coupled between the VQ pad and the Vss; and
at least one second NMOS transistor with a source coupled to the Vss, a drain couple to the control terminal, and a gate coupled to the pull-down circuitry,
wherein the pull-down circuitry delays the turned-off state of the second PMOS transistor for the predetermined period of time.

12. The repair circuitry of claim 11, wherein the pull-down circuitry comprises:
at least one capacitor coupled to the VQ pad; and
at least one resistor coupled between the at least one capacitor and the Vss with a common terminal of the at least one resistor and the at least one capacitor coupled to the gate of the at least one second NMOS transistor.

13. The repair circuitry of claim 11, wherein the pull-down circuitry comprises:
at least one resistor coupled to the VQ pad;
at least one capacitor coupled between the at least one resistor and the Vss; and
an inverter having an input end coupled to a common terminal of the at least one resistor and the at least one capacitor and an output end coupled to the gate of the at least one second NMOS transistor.

14. The repair circuitry of claim 10, further comprising:
at least one second switching device controlled by a predetermined bit-line and coupled between the at least one first switching device and the at least one electrical fuse.

15. The repair circuitry of claim 14, wherein the at least one second switching device is a PMOS transistor, and the predetermined bit-line is coupled to the gate of the PMOS transistor through an odd number of inverters.

16. The repair circuitry of claim 10, further comprising:
at least one third switching device controlled by a predetermined word-line and coupled between the at least one electrical fuse and the Vss.

17. The repair circuitry of claim 16, wherein the at least one third switching device is an NMOS transistor and the predetermined word-line is coupled to the gate of the NMOS transistor through an even number of inverters.

18. A method for preventing an electrical fuse from being blown during an electrostatic discharge (ESD) event, the method comprising:
providing a switching device coupled between a complimentary lower voltage supply source (Vss) and the electrical fuse; and
turning off the switching device upon an application of a positive high voltage for the ESD event at a positive voltage supply (VQ) pad for a predetermined period of time;
whereby blocking stray currents of the ESD during ESD events.

19. The method of claim 18 further comprising:
turning on the switching device after a predetermined period of time subsequent to the application of the positive high voltage at the VQ pad.

20. The method of claim 18, wherein the switching device is an NMOS transistor.
